(19) United States
(12) Patent Application Publication
(10) Pub. No.: US 2026/0116284 A1
(43) Pub. Date: Apr. 30, 2026

(54) METHOD OF CONTROLLING TARGETED ILLUMINATION

(71) Applicant: Volvo Car Corporation, Göteborg (SE)

(72) Inventors: Daniel Young, Summerville, SC (US); Josh Crim, Summerville, SC (US); Peter Barcia, Summerville, SC (US); Derek Boesch, Summerville, SC (US); Andrew Fiorino, Charleston, SC (US); Brian Burgard, Summerville, SC (US); Giovanni Spiritoso, Summerville, SC (US); William Figueroa, Summerville, SC (US)

(73) Assignee: Volvo Car Corporation, Göteborg (SE)

(21) Appl. No.: 18/929,794

(22) Filed: Oct. 29, 2024

(51) Int. Cl. B60Q 1/34

(52) U.S. Cl. CPC B60Q 1/346

(57) ABSTRACT

A system is described. The system comprises: a plurality of auxiliary lights positioned at one or more locations of a vehicle; a sensor module configured to generate sensor data; a processor communicatively coupled to the sensor module, and the plurality of auxiliary lights, the processor storing instructions in non-transitory memory. The processor is operable to: receive the sensor data from the sensor module; determine, using an artificial intelligence engine, an anticipated travel route and an anticipated travel path of the vehicle based on the sensor data; correlate a real-time movement along the anticipated travel path with prestored travel path information; predict one or more upcoming dynamic navigational changes along the anticipated travel path based on the correlation; and selectively activate, using the artificial intelligence engine, one or more auxiliary lights to illuminate the anticipated travel path of the vehicle based on the one or more upcoming dynamic navigational changes.

### FIELD OF THE INVENTION

The present disclosure relates generally to vehicle lighting systems. More specifically, the present disclosure relates to a system and method of controlling targeted illumination of a vehicle.

### BACKGROUND

Current vehicles often lack adequate lighting to assist operators in seeing their surroundings during various maneuvers, including backing up, turning, or navigating tight spaces. While existing lighting systems, such as reverse lights, serve primarily to alert others that the vehicle is in motion, they are not designed to provide sufficient illumination from the operator's perspective. This can lead to challenges when safely executing maneuvers, especially in low-light conditions. Additionally, standard headlights typically focus on the path directly in front of the vehicle, which does not account for the broader area that needs to be observed when making turns or changing lanes.

Therefore, there is a long-felt need for a system and method of controlling targeted illumination.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus, and/or computer program products are presented that facilitate controlling targeted illumination.

In an aspect, a system is described. The system comprises: a plurality of auxiliary lights positioned at one or more locations of a vehicle; a sensor module configured to detect at least one of current route information, real-time movement of the vehicle, real-time environmental conditions, real-time vehicle operating conditions, real-time traffic conditions, real-time travel path information and obstacles information and to generate sensor data based on the detection; a processor, with stored instructions in non-transitory memory, communicatively coupled to the sensor module, and the plurality of auxiliary lights. The processor is operable to: receive the sensor data from the sensor module; determine, using an artificial intelligence engine, an anticipated travel route and an anticipated travel path of the vehicle based on the sensor data; correlate the real-time movement of the vehicle along the anticipated travel path with prestored travel path information; predict one or more upcoming dynamic navigational changes along the anticipated travel path based on the correlation; and selectively activate, using the artificial intelligence engine, one or more auxiliary lights among the plurality of auxiliary lights to illuminate the anticipated travel path of the vehicle based on the one or more upcoming dynamic navigational changes.

In one aspect, a method is described. The method comprises: receiving sensor data from a sensor module; determining, using an artificial intelligence engine, an anticipated travel route and an anticipated travel path of a vehicle based on the sensor data; correlating a real-time movement of the vehicle along the anticipated travel path with prestored travel path information; predicting one or more upcoming dynamic navigational changes along the anticipated travel path based on the correlation; and selectively activating, using the artificial intelligence engine, one or more auxiliary lights among a plurality of auxiliary lights to illuminate the anticipated travel path of the vehicle based on the one or more upcoming dynamic navigational changes.

In one aspect, a non-transitory computer readable storage medium is described. The non-transitory computer readable storage medium comprising a sequence of instructions, which when executed by a processor causes: receiving sensor data from a sensor module; determining, using an artificial intelligence engine, an anticipated travel route and an anticipated travel path of a vehicle based on the sensor data; correlating a real-time movement of the vehicle along the anticipated travel path with prestored travel path information; predicting one or more upcoming dynamic navigational changes along the anticipated travel path based on the correlation; and selectively activating, using the artificial intelligence engine, one or more auxiliary lights among a plurality of auxiliary lights to illuminate the anticipated travel path of the vehicle based on the one or more upcoming dynamic navigational changes.

The methods and systems disclosed herein may be implemented in any means for achieving various aspects and may be executed in a form of a non-transitory computer readable storage medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1 illustrates a system, according to one or more embodiments.

FIG. 2 illustrates a method, according to one or more embodiments.

FIG. 3 illustrates a non-transitory computer readable storage medium block diagram, according to one or more embodiments.

FIG. 4 illustrates a vehicle diagram of a system according to one or more embodiments.

FIG. 5 illustrates a system for activating auxiliary lights during reverse movement of a vehicle according to one or more embodiments.

FIG. 6 illustrates a system for activating auxiliary lights during the anticipation of a left turn by a vehicle according to one or more embodiments.

FIG. 7 illustrates a system for activating auxiliary lights during the anticipation of a right turn by a vehicle according to one or more embodiments.

FIG. 8 illustrates a system for activating auxiliary lights when an obstacle is detected on the right-side of a vehicle according to one or more embodiments.

FIG. 9 illustrates an embodiment of a system for activating auxiliary lights when an obstacle is detected in left side of a vehicle according to one or more embodiments.

FIGS. 10A-10B illustrate a system for activating auxiliary lights during a lane change of a vehicle according to one or more embodiments.

FIG. 11 illustrates an interactive menu of a vehicle for controlling auxiliary lighting configuration according to one or more embodiments.

FIG. 12 illustrates a communication flow between a system and a vehicle, according to one or more embodiments.

FIG. 13 shows an example block diagram for an artificial intelligence engine used in activating one or more auxiliary lights among a plurality of auxiliary lights of a vehicle according to one or more embodiments.

FIG. 14A shows a structure of the neural network/machine learning model with a feedback loop.

FIG. 14B shows a structure of the neural network/machine learning model with reinforcement learning.

FIG. 15A shows a block diagram of the cyber security module in view of the system and server.

FIG. 15B shows an embodiment of the cyber security module.

FIG. 15C shows another embodiment of the cyber security module.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

Unless defined otherwise, all technical and scientific terms used herein have the same meaning as commonly understood by one with ordinary skill in the art.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the described subject matter herein. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc., in question is or is not removable.

As used herein, the term “or” means an inclusive “or” rather than an exclusive “or.” That is, unless specified otherwise, or clear from context. “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a computer readable storage medium for execution by, or to control the operation of, data processing apparatus. The computer readable storage medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc., may embed a computer. Computer readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship between the client and server arises by virtue of computer programs running on the respective computers and having a client-server relationship with each other.

Embodiments may comprise or utilize a special purpose or general purpose computer including computer hardware. Embodiments within the scope of the present invention may also include physical and other computer readable media for carrying or storing computer-executable instructions and/or data structures. Such computer readable media can be any media accessible by a general purpose or special purpose computer system. Computer readable media that store computer-executable instructions are physical storage media. Computer readable media that carry computer-executable instructions are transmission media. Thus, by way of example and not limitation, embodiments of the invention can comprise at least two distinct kinds of computer readable media: physical computer readable storage media and transmission computer readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory computer readable storage medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory computer readable storage medium and/or a system may embody the various operations, processes, and methods disclosed herein. Accordingly, the specifications and drawings are illustrative rather than restrictive.

Physical computer readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer readable media includes combinations of the above, that enable the transport of electronic data between computer systems and/or modules and/or other electronic devices. Further, upon reaching various computer system components, program code in the form of computer-executable instructions or data structures can be transferred automatically from transmission computer readable media to physical computer readable storage media (or vice versa). For example, computer-executable instructions or data structures received over a network or data link can be buffered in RAM within a Network Interface Controller (NIC), and then eventually transferred to computer system RAM and/or to less volatile computer readable physical storage media at a computer system. Thus, computer system components that also (or even primarily) utilize transmission media may include computer readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together into a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

The following terms and phrases, unless otherwise indicated, shall have the following meanings.

As used herein, the term “auxiliary lights” refers to additional lights installed on a vehicle to serve specific purposes beyond the standard headlights and taillights. Examples include fog lights, side marker lights, off-road lights, or emergency lights.

As used herein, the term “one or more locations” refers to the positioning of components, such as lights or sensors, at different points on the vehicle. The one or more locations are selected from front, rear, corners, left side, right side, undercarriage, roof, and wheel barrels of the vehicle.

As used herein, the term “sensor module” refers to a compact electronic device that integrates one or more sensors along with the necessary electronics to process sensor data. These modules detect and measure physical properties, environmental conditions, or system statuses, then convert the information into data that can be used by other systems for control, monitoring, or decision-making.

As used herein, the term “current route information” refers to data describing the planned journey, including the starting point (source), final destination, total distance, estimated time to arrival, any points of interest along the way (waypoints), the current location of the vehicle, the selected navigation route, the types of roads involved (e.g., highways or local streets), and detailed turn-by-turn instructions.

As used herein, the term “real-time movement” refers to live data tracking the current position, speed, direction of travel, and patterns in movement, such as acceleration, deceleration, or stops of the vehicle.

As used herein, the term “real-time environmental conditions” refers to current external factors affecting the driving environment, such as the level of ambient light, the presence of reflective surfaces, weather conditions (e.g., rain or fog), visibility range, light sources like streetlights, and the intensity or rate of precipitation.

As used herein, the term “real-time vehicle operating conditions” refers to data on an operational state, including speed, acceleration, engine status, steering angle, gear position, whether the headlights are on or off, and whether any attachments (e.g., trailers) are connected to the vehicle.

As used herein, the term “real-time traffic conditions” refers to live information about the surrounding traffic, including the number of vehicles on the road (traffic density), the proximity of other vehicles, the status of traffic lights, lane occupancy, road closures, and suggestions for alternative routes based on traffic conditions.

As used herein, the term “real-time travel path information” refers to detailed data about the road immediately ahead, including upcoming turns, curves in the road, changes in elevation, road signs, and the condition of the road surface (e.g., wet, icy, or rough).

As used herein, the term “obstacles information” refers to data about objects detected around the vehicle, including stationary objects (e.g., barriers), moving vehicles, pedestrians, road infrastructure (e.g., signs or poles), and any hazards present on the road (e.g., debris or potholes).

As used herein, the term “one or more upcoming dynamic navigational changes” refers to anticipated changes in the real-time movement or route of the vehicle, including upcoming turns, changes in lighting, acceleration, or deceleration, parking maneuvers, reversing, changes in speed or direction, and lane changes.

As used herein, the term “anticipated travel route” refers to the overall planned journey from a starting point to a destination, including the general route selected, such as highways or city streets, and any intermediate stops or waypoints.

As used herein, the term “anticipated travel path” refers to the specific roads or lanes the vehicle takes at any given moment along the travel route to reach its destination. This includes the exact path being followed, such as turns or lane choices, at each stage of the journey.

As used herein, the term “source” refers to the starting point or origin of a journey, route, or process. In navigation, it refers to the location from which travel begins.

As used herein, the term “destination” refers to the end point or goal of a journey, route, or process. It is the location where travel is intended to conclude.

As used herein, the term “distance” refers to the measurable space or extent between the source and the destination. It is typically quantified in units such as miles or kilometers.

As used herein, the term “estimated travel time” refers to the predicted duration required to travel from the source to the destination. It takes into account factors like distance, speed limits, and typical traffic conditions.

As used herein, the term “waypoints of interest” refers to specific locations or points along a route that are noteworthy or relevant to the journey. The waypoints of interest include landmarks, rest stops, or places of interest.

As used herein, the term “geographic location of the vehicle” refers to the current position of a vehicle as determined by geographic coordinates (latitude and longitude) or other location-tracking methods.

As used herein, the term “navigation route” refers to the planned path or sequence of directions from the source to the destination. The navigation route includes the specific roads or paths to be taken.

As used herein, the term “road type” refers to the classification or characteristics of a road, such as highway, street, lane, or rural road. The road type can influence travel time and route planning.

As used herein, the term “turn-by-turn directions” refers to detailed instructions for navigating a route, specifying when and where to make each turn or maneuver along the way. They guide the traveler step-by-step from the source to the destination.

As used herein, the term “current location of the vehicle” refers to the present geographic position of a vehicle, determined using GPS coordinates or other location-tracking technologies. It indicates where the vehicle is at a given moment.

As used herein, the term “speed of the vehicle” refers to the rate at which a vehicle is traveling, typically measured in units such as miles per hour (mph) or kilometers per hour (km/h). It reflects how quickly the vehicle moves.

As used herein, the term “direction of movement” refers to the orientation or heading of the vehicle's travel relative to a reference direction, such as north, south, east, or west. It indicates the way the vehicle is pointing or traveling.

As used herein, the term “movement pattern” refers to the specific trajectory or behavior of the movement of the vehicle over time, including aspects such as changes in speed, frequent turns, or deviations from a straight path. The movement pattern reflects how the movement of the vehicle varies or follows a particular trend.

As used herein, the term “ambient light levels” refers to the amount of natural or artificial light present in the environment surrounding a vehicle. It affects visibility and can influence the lighting systems of the vehicle.

As used herein, the term “reflective surfaces” refers to objects or surfaces in the environment that bounce light back toward the sensors or cameras of the vehicle. These can include road signs, wet roads, or shiny surfaces that can impact visibility and sensor readings.

As used herein, the term “weather conditions” refers to the state of the atmosphere at a given time and place, including factors such as temperature, humidity, wind, and precipitation. Weather conditions can affect driving safety and vehicle performance.

As used herein, the term “visibility range” refers to the distance over which objects or road features can be clearly seen. The visibility range is influenced by factors such as weather conditions, lighting, and obstructions.

As used herein, the term “light sources within an environment of the vehicle” refers to any sources of light present around or within the surroundings of the vehicle that can affect visibility and sensor performance. This includes streetlights, headlights from other vehicles, and interior lights.

As used herein, the term “rate of precipitation” refers to the amount of precipitation (such as rain, snow, or sleet) falling over a specific period, usually measured in millimeters per hour or inches per hour.

As used herein, the term “acceleration metrics” refers to measurements that describe how quickly a speed of the vehicle is increasing or decreasing. The acceleration metrics include acceleration rate (e.g., meters per second squared) and deceleration rate, which can be used to assess vehicle performance and responsiveness.

As used herein, the term “engine status” refers to the operational condition of the engine of the vehicle, including information on whether it is running or off, its temperature, oil pressure, and other performance indicators. The engine status provides insight into the health and functionality of the engine.

As used herein, the term “steering angle” refers to the angle at which the wheels of the vehicle are turned relative to a longitudinal axis of the vehicle.

As used herein, the term “gear selection” refers to the specific gear in which the vehicle's transmission is currently set (e.g., first, second, third gear).

As used herein, the term “headlights status” refers to the operational state of the headlights of the vehicle, including whether they are on or off, and if they are set to high beam or low beam.

As used herein, the term “vehicle attachment” refers to any accessory or additional component attached to the vehicle, such as a trailer, bike rack, or cargo carrier. These attachments can impact the performance, handling, and safety of the vehicle.

As used herein, the term “traffic density” refers to the concentration of vehicles on a given road or area at a particular time. The traffic density is often measured in vehicles per mile or kilometer and affects the flow of traffic and travel times.

As used herein, the term “vehicle proximity” refers to the distance between the vehicle and other nearby vehicles. The vehicle proximity is a critical factor in maintaining safe following distances and avoiding collisions.

As used herein, the term “traffic light status” refers to the current state of traffic signals at intersections, including whether they are red, yellow, or green, constant, or blinking. This status determines whether vehicles should stop, prepare to stop, or proceed.

As used herein, the term “lane occupancy” refers to the extent to which lanes on a road are occupied by vehicles. It indicates how many lanes are being used or blocked, which can affect traffic flow and routing decisions.

As used herein, the term “road closures” refers to the condition where certain roads are blocked or inaccessible due to construction, accidents, or other factors. Road closures can impact travel routes and require alternate planning.

As used herein, the term “alternate route suggestions” refers to recommendations for different routes to take in order to avoid traffic congestion, road closures, or other obstacles. These suggestions help in finding more efficient or less congested paths to a destination.

As used herein, the term “anticipated turns” refers to upcoming changes in direction that a vehicle will need to make during its journey. This includes left or right turns at intersections or curves in the road.

As used herein, the term “road curvature” refers to the degree to which a road bends or curves. The road curvature affects driving dynamics and requires adjustments in steering and speed to navigate safely.

As used herein, the term “elevation changes” refers to variations in the road's altitude or slope, such as inclines or declines. These changes can impact vehicle performance and fuel efficiency.

As used herein, the term “path signs” refers to signage along the route that provides directional guidance, warnings, or information about the road ahead. This includes road signs, directional markers, and information boards.

As used herein, the term “road surface conditions” refers to the state of the road surface, including its texture and quality.

As used herein, the term “stationary objects” refers to objects that are not moving and are located around the vehicle, such as parked cars, road signs, barriers, or buildings. These objects can affect the path or parking of the vehicle.

As used herein, the term “moving vehicles” refers to vehicles that are currently in motion around the vehicle, including those traveling in the same or opposite direction.

As used herein, the term “pedestrians” refers to individuals walking or standing near the roadway.

As used herein, the term “road infrastructure” refers to the physical components of the road system, including lanes, intersections, traffic signals, road markings, and bridges.

As used herein, the term “road hazards” refers to potential dangers or obstacles on the road that can impact driving safety, such as debris, potholes, ice patches, or sudden obstacles.

As used herein, the term “auxiliary lighting configuration” refers to the specific arrangement and parameters governing the operation of the auxiliary lights in a vehicle, including the intensity, direction, and beam pattern of the activated auxiliary lights from among the plurality of available lights.

As used herein, the term “intensity” refers to the brightness level of the auxiliary lights, which affects how well the light illuminates the road or surroundings.

As used herein, the term “direction” refers to the orientation or angle at which the auxiliary lights are aimed, influencing the area of illumination and visibility.

As used herein, the term “beam pattern” refers to the shape and spread of the light emitted by the auxiliary lights, which determines how the light covers the road or environment (e.g., focused beam, wide beam, or floodlight).

As used herein, the term “glare” refers to a visual impairment caused by excessive brightness or intense light that interferes with the ability to see clearly. In the context of image and video capture, glare refers to the unwanted reflection or direct light that can obscure or distort the visibility of objects, details, or features within the captured visuals. This can be due to sources such as bright headlights, sunlight, or reflections from surfaces, impacting the quality and clarity of the image or video.

As used herein, the term “auxiliary lighting adjustments” refer to modifications made to the auxiliary lights within a vehicle by the operator, beyond the primary headlights or standard interior lights. These adjustments are accessible through an interactive menu displayed in the vehicle and may include controls for brightness, color temperature, activation/deactivation, and the positioning or direction of the auxiliary lights, as well as zone-specific lighting configurations.

As used herein, the term “auxiliary lighting control” refers to the interface or system that allows an operator to manage and adjust the auxiliary lights within a vehicle. This control system is typically accessible through an interactive menu displayed on a screen of the vehicle and enables the operator to perform actions such as turning auxiliary lights on or off, increasing or decreasing the light intensity, adjusting the direction or angle of the auxiliary light, etc.

As used herein, the term “infotainment system” or “infotainment unit” or “in-vehicle infotainment system” (IVI) as used herein refers to a combination of systems which are used to deliver entertainment and information. In an example, the information may be delivered to the driver and the passengers of a vehicle through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

As used herein, the term “bidirectional communication” refers to an exchange of data between two components. In an example, the first component can be a vehicle, and the second component can be an infrastructure that is enabled by a system of hardware, software, and firmware. This communication is typically wireless. In another example, the first component can be a charging system, and the second component can be a charging station.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

The term “vehicle” as used herein refers to a thing used for transporting people or goods. Automobiles, cars, trucks, buses, etc., are examples of vehicles.

As used herein, the term “vehicle computer system” refers to a system in automotive electronics that controls one or more of the electrical systems or subsystems in a vehicle. The computer executes a large number of different software functions in the powertrain, chassis, driver assistance, and infotainment domains, etc., that are executed on separate control units. The vehicle computer system may be communicatively coupled with an external device of a user.

As used herein, the term “communication” refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection. The term “communication” includes systems that combine other more specific types of communication, such as V2I (Vehicle-to-Infrastructure), V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication. V2X communication is the transmission of information from a vehicle to any entity that may affect the vehicle, and vice versa. The main motivations for developing V2X are occupant safety, road safety, traffic efficiency and energy efficiency. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.). Further, the emergency communication apparatus is configured on a computer with the communication function and is connected for bidirectional communication with the on-vehicle emergency report apparatus by a communication line through a radio station and a communication network such as a public telephone network or by satellite communication through a communication satellite. The emergency communication apparatus is adapted to communicate, through the communication network, with communication terminals including a road management office, a police station, a fire department, and a hospital. The emergency communication apparatus can also be connected online with the communication terminals of the persons or vehicles concerned, associated with the occupant or vehicle, and the driver or vehicle receiving the service of the emergency-reporting vehicle.

The terms “non-transitory computer readable storage medium” and “computer readable storage medium” include a single medium or multiple media such as a centralized or distributed database, and/or associated caches and servers that store one or more sets of instructions. Further, the terms “non-transitory computer readable storage medium” and “computer readable storage medium” include any tangible medium that is capable of storing, encoding, or carrying a set of instructions for execution by a processor that, for example, when executed, cause a system to perform any one or more of the methods or operations disclosed herein. As used herein, the term “computer readable storage medium” is expressly defined to include any type of computer readable storage device and/or storage disk and to exclude propagating signals.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in an RS-232 serial transmission. A software handshake sends codes such as “synchronize” (SYN) and “acknowledge” (ACK) in a TCP/IP transmission.

The term “in communication with” as used herein, refers to any coupling, connection, or interaction using electrical signals to exchange information or data, using any system, hardware, software, protocol, or format, regardless of whether the exchange occurs wirelessly or over a wired connection.

As used herein, the term “network” may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and/or operation of possible implementations of systems, computer-implementable methods and/or computer program products according to one or more embodiments described herein. In this regard, each block in the flowchart or block diagrams can represent a module, segment, and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein can also be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments are for purposes of illustration but are not exhaustive or limiting to the embodiments described herein. Many modifications and variations will be apparent to those of ordinary skill in the art without departing from the scope and spirit of the embodiments described. The terminology used herein best explains the principles of the embodiments, the practical application and/or technical improvement over technologies found in the marketplace, and/or to enable others of ordinary skill in the art to understand the embodiments described herein.

Business problem: As vehicles evolve with integrated reverse and maneuvering lighting systems, inadequate visibility during maneuvers remains a significant concern, leading to accidents and unsafe driving conditions. Existing lighting solutions often do not offer sufficient illumination in critical situations, relying on standard lighting that fails to adapt to varying environments. This can cause delays in maneuvering, heighten the risk of accidents, and create potential liability issues for vehicle owners and operators.

Business solution: The present system enhances vehicle safety and maneuverability by integrating advanced auxiliary lighting with real-time data and artificial intelligence. The present system includes a sensor module that detects a range of factors, including current route information, the movement of the vehicle, environmental and operating conditions, and traffic conditions. This data is processed by an artificial intelligence engine, which determines the anticipated travel route and path. The present system predicts upcoming navigational changes and selectively activates the auxiliary lights to illuminate the anticipated path accordingly. This approach improves driver visibility during critical maneuvers, such as reversing and turning, by providing targeted illumination based on real-time conditions and predicted changes. As a result, the present system enhances safety, accuracy, and convenience for drivers, addressing limitations of current lighting technologies.

Technical problem: Current lighting systems in vehicles are inadequate for enhancing driver visibility during complex maneuvers, such as reversing and turning, especially under low-light conditions. Existing reverse lighting is primarily designed to alert others of a reverse mode of the vehicle rather than to assist the driver. This results in insufficient illumination of the area behind the vehicle, making it challenging to safely back up. Additionally, standard headlights do not effectively illuminate areas where the vehicle will navigate during turns, leading to difficulties in accurately positioning the vehicle and seeing lane markers at night.

Technical Solution: The present system enhances vehicle safety and visibility during maneuvers by automating the activation of auxiliary lights based on real-time data analysis. This system utilizes sensors to collect information about the surroundings of the vehicle, including obstacles and environmental conditions. By processing this data through an artificial intelligence engine, the present system predicts the driver's intended path and activates the appropriate auxiliary lights accordingly. This automation eliminates the need for manual adjustments, ensuring optimal lighting at all times. Consequently, driver visibility is improved, significantly reducing the likelihood of accidents caused by poor lighting conditions.

Technical Result: The present system improves visibility and safety for drivers during maneuvers. By dynamically adjusting the auxiliary lighting based on real-time data and predictive analysis, the present system enhances illumination in critical areas, particularly when reversing or turning. This targeted lighting significantly improves the driver's ability to see their surroundings, reducing the risk of accidents caused by insufficient visibility. The present system addresses the limitations of traditional lighting technologies, providing a safer and more effective driving experience in various conditions.

### Technical Details Specific to Technical Result:

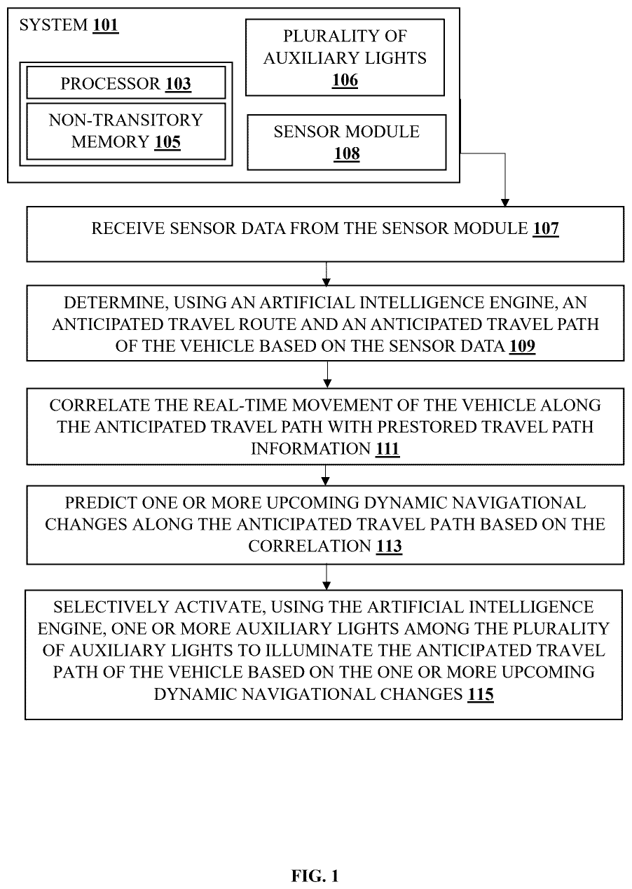

In an aspect, a system is described. As an example, FIG. 1 illustrates a system 101, according to one or more embodiments. The system 101 comprises: a plurality of auxiliary lights 106 positioned at one or more locations of a vehicle; a sensor module 108 configured to detect at least one of current route information, real-time movement of the vehicle, real-time environmental conditions, real-time vehicle operating conditions, real-time traffic conditions, real-time travel path information and obstacles information and generate sensor data based on the detection; a processor 103 communicatively coupled to the plurality of auxiliary lights, the sensor module, and the processor 103 storing instructions in non-transitory memory 105. The processor 103 is operable to: receive the sensor data from the sensor module (at step 107); determine, using an artificial intelligence engine, an anticipated travel route and an anticipated travel path of the vehicle based on the sensor data (at step 109); correlate the real-time movement of the vehicle along the anticipated travel path with prestored travel path information (at step 111); predict one or more upcoming dynamic navigational changes along the anticipated travel path based on the correlation (at step 113); and selectively activate, using the artificial intelligence engine, one or more auxiliary lights among the plurality of auxiliary lights to illuminate the anticipated travel path of the vehicle based on the one or more upcoming dynamic navigational changes (at step 115).

In one embodiment, the sensor module comprises at least one of radar-based sensors, Laser Detection and Ranging (LADAR), Light Detection and Ranging (LIDAR), cameras, vision-based sensors, light-based sensors, optical sensors, infrared sensors, temperature sensors, GPS sensors, audio sensors, proximity sensors, acceleration sensors, gyroscopes, and steering angle sensors.

In one embodiment, the one or more locations are selected from front, rear, corners, left side, right side, undercarriage, roof, and wheel barrels of the vehicle.

In one embodiment, the current route information comprises source, destination, distance, estimated travel time, waypoints of interest, geographic location of the vehicle, navigation route, road type, and turn-by-turn directions.

In one embodiment, the real-time movement of the vehicle comprises current location of the vehicle, speed of the vehicle, direction of movement of the vehicle, and movement pattern of the vehicle.

In one embodiment, the real-time environmental conditions comprise ambient light levels, reflective surfaces, weather conditions, visibility range, light sources within an environment of the vehicle, and rate of precipitation.

In one embodiment, the real-time vehicle operating condition comprises acceleration metrics, engine status, steering angle, gear selection, headlights status, and a vehicle attachment.

In one embodiment, the real-time traffic conditions comprise traffic density, vehicle proximity, traffic light status, lane occupancy, road closures, and alternate route suggestions.

In one embodiment, the real-time travel path information comprises anticipated turns, road curvature, elevation changes, path signs, and road surface conditions.

In one embodiment, the obstacles information comprises stationary objects, moving vehicles, pedestrians, road infrastructure, and road hazards detected within an area around the vehicle.

In one embodiment, the one or more upcoming dynamic navigational changes comprise anticipated turns, lighting changes, acceleration, deceleration, movement of the vehicle within a parking space, reverse movement, speed changes, direction changes, and lane changes.

In one embodiment, the processor 103 is operable to activate one or more additional auxiliary lights among the plurality of auxiliary lights 106. In one embodiment, the processor 103 is operable to adjust auxiliary lighting configuration of the one or more auxiliary lights.

In one embodiment, the auxiliary lighting configuration comprises intensity, direction, and beam pattern of the one or more auxiliary lights that are activated among the plurality of auxiliary lights. In one embodiment, the processor 103 is operable to determine that the auxiliary lighting configuration is within a threshold. In one embodiment, the processor 103 is operable to activate the one or more additional auxiliary lights among the plurality of auxiliary lights 106 if the auxiliary lighting configuration is less than the threshold. In one embodiment, the processor 103 is operable to adjust the auxiliary lighting configuration of the one or more auxiliary lights if the auxiliary lighting configuration is less than the threshold.

In one embodiment, the processor 103 is operable to detect glare in at least one of an image and a video captured during reverse movement. In one embodiment, the image and the video are captured by a rear camera attached to the vehicle. In one embodiment, the processor 103 is operable to remove the glare in at least one of the image and the video using a filter. In one embodiment, the filter is configured to remove the glare based on the real-time environmental conditions of the vehicle and current auxiliary lighting configuration. In one embodiment, the processor 103 is operable to adjust the auxiliary lighting configuration of the one or more auxiliary lights in response to the detected glare.

In one embodiment, the processor 103 is operable to display an interactive menu onto a display of the vehicle depicting auxiliary lighting controls of the one or more auxiliary lights upon activation. In one embodiment, the auxiliary lighting controls allow an operator to adjust the auxiliary lighting configuration of the one or more auxiliary lights. In one embodiment, the auxiliary lighting controls allow the operator to at least one of activate and deactivate the one or more auxiliary lights. In one embodiment, the processor 103 is operable to monitor auxiliary lighting adjustments specific to an occupant of the vehicle and store the auxiliary lighting adjustments as preferences in a database. In one embodiment, the processor 103 is operable to recognize an identity of a vehicle occupant and provide the auxiliary lighting adjustments based on the preferences for that specific occupant in the future.

In one embodiment, the artificial intelligence engine is trained based on the sensor data. In one embodiment, the artificial intelligence engine communicates instructions to the processor to activate the one or more auxiliary lights among the plurality of auxiliary lights 106 based on learning.

How Technical Solution is a Technological Advancement: The technical solution enhances vehicle safety and visibility during maneuvers by automating the activation of auxiliary lights based on real-time data analysis. This automation reduces the need for manual adjustments, ensuring that lighting remains optimal for any given situation. As a result, driver visibility is significantly improved, lowering the risk of accidents due to inadequate lighting. The system delivers a more efficient and safer driving experience, especially during complex maneuvers, by providing timely and targeted illumination that boosts situational awareness and decision-making.

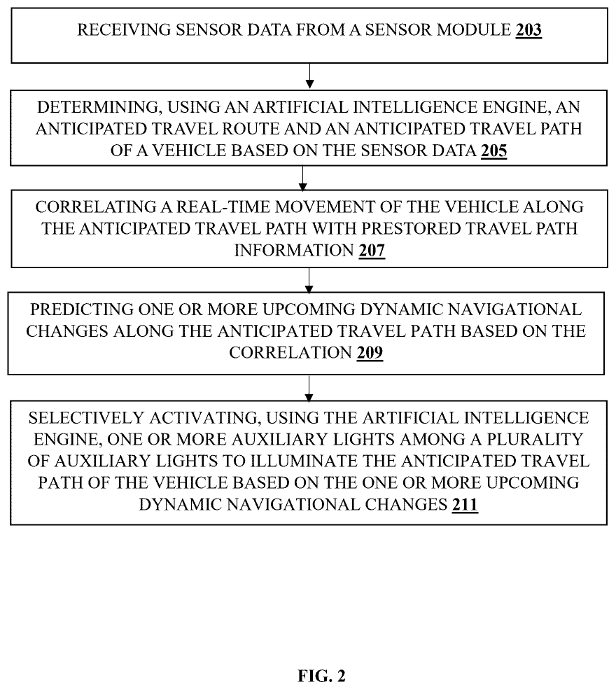

In one aspect, a method is described. As an example, FIG. 2 illustrates a method according to one or more embodiments. The method comprises the following technical steps: receiving sensor data from a sensor module (at step 203); determining, using an artificial intelligence engine, an anticipated travel route and an anticipated travel path of a vehicle based on the sensor data (at step 205); correlating a real-time movement of the vehicle along the anticipated travel path with prestored travel path information (at step 207); predicting one or more upcoming dynamic navigational changes along the anticipated travel path based on the correlation (at step 209); and selectively activating, using the artificial intelligence engine, one or more auxiliary lights among a plurality of auxiliary lights to illuminate the anticipated travel path of the vehicle based on the one or more upcoming dynamic navigational changes (at step 211).

In one embodiment, the method further comprises: activating one or more additional auxiliary lights from the plurality of auxiliary lights.

In one embodiment, the method further comprises: activating one or more additional auxiliary lights from the plurality of auxiliary lights.

In one embodiment, the auxiliary lighting configuration comprises intensity, direction, and beam pattern of the one or more auxiliary lights that are activated among the plurality of auxiliary lights.

In one embodiment, the method further comprises: determining that the auxiliary lighting configuration of the one or more auxiliary lights is within a threshold.

In one embodiment, the method further comprises: activating the one or more additional auxiliary lights among the plurality of auxiliary lights if the auxiliary lighting configuration of the one or more auxiliary lights is less than the threshold.

In one embodiment, the method further comprises: adjusting the auxiliary lighting configuration if the auxiliary lighting configuration is less than the threshold.

In one embodiment, the method further comprises: detecting glare in at least one of an image and a video captured during reverse movement.

In one embodiment, the image and the video are captured by a rear camera attached in the vehicle.

In one embodiment, the method further comprises: removing the glare in at least one of the image and the video using a filter.

In one embodiment, the filter is configured to remove the glare based on real-time environmental conditions of the vehicle and current auxiliary lighting configuration.

In one embodiment, the method further comprises: adjusting the auxiliary lighting configuration of the one or more auxiliary lights in response to the detected glare.

In one embodiment, the method further comprises: displaying an interactive menu onto a display of the vehicle depicting auxiliary lighting controls of the one or more auxiliary lights upon activation.

In one embodiment, the auxiliary lighting controls allow an operator to adjust auxiliary lighting configuration of the one or more auxiliary lights.

In one embodiment, the auxiliary lighting controls allow the operator to at least one of activate and deactivate the one or more auxiliary lights.

In one embodiment, the method further comprises: monitoring auxiliary lighting adjustments specific to an occupant of the vehicle and storing the auxiliary lighting adjustments as preferences in a database.

In one embodiment, the method further comprises: recognizing an identity of a vehicle occupant and providing the auxiliary lighting adjustments based on the preferences for that specific occupant in future.

In one embodiment, the method further comprises: training the artificial intelligence engine based on the sensor data.

In one embodiment, the method further comprises: communicating, using the artificial intelligence engine, instructions to a processor to activate the one or more auxiliary lights among the plurality of auxiliary lights based on learning.

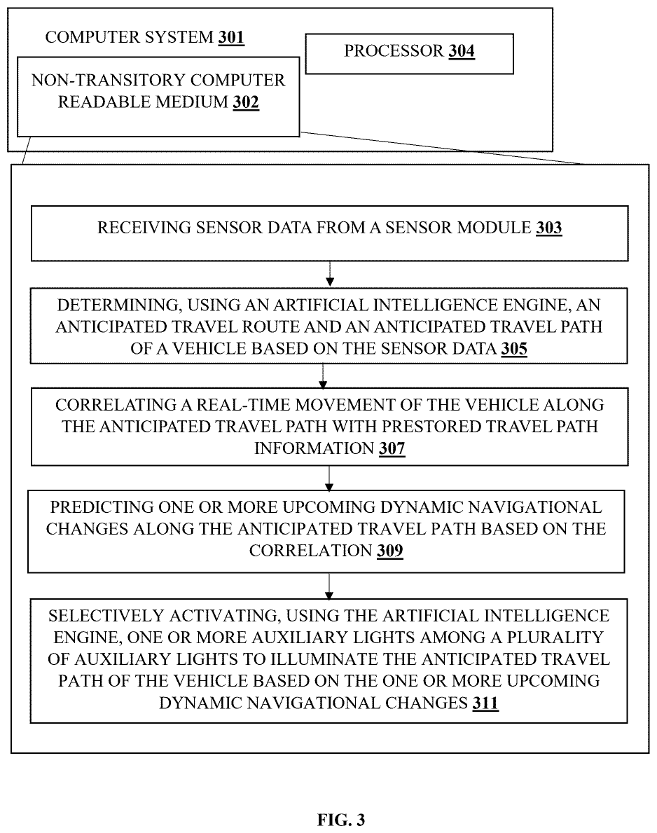

As an example, FIG. 3 illustrates a non-transitory computer readable storage medium 302, according to one or more embodiments. According to an embodiment, disclosed is a computer system 301 comprising the non-transitory computer readable storage medium 302 having stored thereon instructions executable by a processor 304 to perform operations comprising: receiving sensor data from a sensor module (at step 303); determining, using an artificial intelligence engine, an anticipated travel route and an anticipated travel path of a vehicle based on the sensor data (at step 305); correlating a real-time movement of the vehicle along the anticipated travel path with prestored travel path information (at step 307); predicting one or more upcoming dynamic navigational changes along the anticipated travel path based on the correlation (at step 309); and selectively activating, using the artificial intelligence engine, one or more auxiliary lights among a plurality of auxiliary lights to illuminate the anticipated travel path of the vehicle based on the one or more upcoming dynamic navigational changes (at step 311).

In one embodiment, the non-transitory computer readable storage medium 302 further causes: activating one or more additional auxiliary lights from the plurality of auxiliary lights.

In one embodiment, the non-transitory computer readable storage medium 302 further causes: activating one or more additional auxiliary lights from the plurality of auxiliary lights.

In one embodiment, the auxiliary lighting configuration comprises intensity, direction, and beam pattern of the one or more auxiliary lights that are activated among the plurality of auxiliary lights.

In one embodiment, the non-transitory computer readable storage medium 302 further causes: determining that the auxiliary lighting configuration of the one or more auxiliary lights is within a threshold.

In one embodiment, the non-transitory computer readable storage medium 302 further causes: activating the one or more additional auxiliary lights among the plurality of auxiliary lights if the auxiliary lighting configuration of the one or more auxiliary lights is less than the threshold.

In one embodiment, the non-transitory computer readable storage medium 302 further causes: adjusting the auxiliary lighting configuration if the auxiliary lighting configuration is less than the threshold.

In one embodiment, the non-transitory computer readable storage medium 302 further causes: detecting glare in at least one of an image and a video captured during reverse movement.

In one embodiment, the image and the video are captured by a rear camera attached in the vehicle.

In one embodiment, the non-transitory computer readable storage medium 302 further causes: removing the glare in at least one of the image and the video using a filter.

In one embodiment, the filter is configured to remove the glare based on real-time environmental conditions of the vehicle and current auxiliary lighting configuration.

In one embodiment, the non-transitory computer readable storage medium 302 further causes: adjusting the auxiliary lighting configuration of the one or more auxiliary lights in response to the detected glare.

In one embodiment, the non-transitory computer readable storage medium 302 further causes: displaying an interactive menu onto a display of the vehicle depicting auxiliary lighting controls of the one or more auxiliary lights upon activation.

In one embodiment, the auxiliary lighting controls allow an operator to adjust auxiliary lighting configuration of the one or more auxiliary lights.

In one embodiment, the auxiliary lighting controls allow the operator to at least one of activate and deactivate the one or more auxiliary lights.

In one embodiment, the non-transitory computer readable storage medium 302 further causes: monitoring auxiliary lighting adjustments specific to an occupant of the vehicle and storing the auxiliary lighting adjustments as preferences in a database.

In one embodiment, the non-transitory computer readable storage medium 302 further causes: recognizing an identity of a vehicle occupant and providing the auxiliary lighting adjustments based on the preferences for that specific occupant in future.

In one embodiment, the non-transitory computer readable storage medium 302 further causes: training the artificial intelligence engine based on the sensor data.

In one embodiment, the non-transitory computer readable storage medium 302 further causes: communicating, using the artificial intelligence engine, instructions to the processor 304 to activate the one or more auxiliary lights among the plurality of auxiliary lights based on learning.

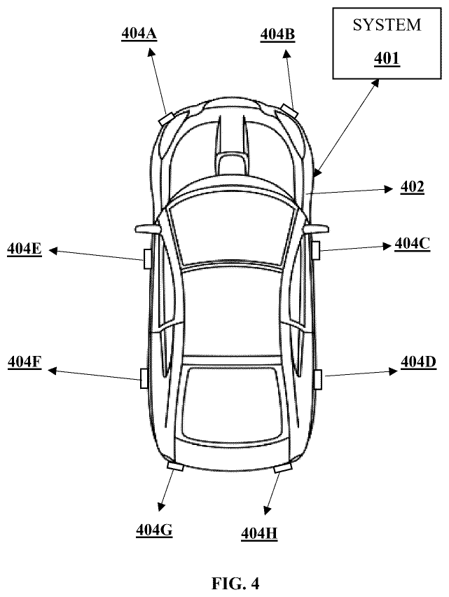

As an example, FIG. 4 illustrates a diagram of a system 401 according to one or more embodiments. The block diagram comprises the system 401, a vehicle 402 and a plurality of auxiliary lights 404A-H. The plurality of auxiliary lights 404A-H positioned at one or more locations of the vehicle 402. In one embodiment, the one or more locations are selected from front, rear, corners, left side, right side, undercarriage, roof, and wheel barrels of the vehicle 402. The system 401 comprises a sensor module configured to detect at least one of current route information, real-time movement of the vehicle 402, real-time environmental conditions, real-time vehicle operating conditions, real-time traffic conditions, real-time travel path information and obstacles information and generate sensor data based on the detection. The system 401 may utilize at least one of radar-based sensors, Laser Detection and Ranging (LADAR), Light Detection and Ranging (LIDAR), cameras, vision-based sensors, light-based sensors, optical sensors, infrared sensors, temperature sensors, GPS sensors, audio sensors, proximity sensors, acceleration sensors, gyroscopes, and steering angle sensors of the vehicle 402. In one embodiment, the system 401 is integrated into the vehicle 402. The system 401 detects upcoming dynamic navigational changes along an anticipated travel path by correlating real-time movement of the vehicle 402 along the anticipated travel path with prestored travel path information. In one embodiment, the one or more upcoming dynamic navigational changes comprise anticipated turns, lighting changes, acceleration, deceleration, a movement of the vehicle within a parking space, reverse movement, speed changes, direction changes, and lane changes. The system 401 selectively activates, using an artificial intelligence engine, one or more auxiliary lights among the plurality of auxiliary lights 404A-H to illuminate the anticipated travel path of the vehicle 402 based on the one or more upcoming dynamic navigational changes. In one embodiment, the system 401 activates one or more additional auxiliary lights among the plurality of auxiliary lights 404A-H based on the sensor data.

In one embodiment, when the vehicle 402 detects a turn based on the steering angle or turn signal activation, the system 401 will automatically activate the one or more auxiliary lights at the side of the vehicle 402 to illuminate the direction of the turn. For example, if a driver is making a left turn at night, the auxiliary lights on the left side (e.g., 404A and 404E) of the vehicle 402 will turn on, providing better visibility of lane markers, pedestrians, or obstacles.

The system 401 may adjust auxiliary lighting configuration of the one or more auxiliary lights based on the sensor data. The auxiliary lighting configuration may comprise intensity, direction, and beam pattern of the one or more auxiliary lights that are activated among the plurality of auxiliary lights 404A-H. In one embodiment, the system 401 determines that the auxiliary lighting configuration is within a threshold. In one embodiment, the system 401 activates the one or more additional auxiliary lights among the plurality of auxiliary lights if the auxiliary lighting configuration is less than the threshold. In one embodiment, the system 401 adjusts the auxiliary lighting configuration of the auxiliary lights if the auxiliary lighting configuration is less than the threshold.

In one embodiment, during rapid acceleration, especially in low-light conditions, the system 401 may increase the intensity of forward-facing auxiliary lights (404A and 404B) to extend the range of visibility. For example, when the driver accelerates onto a highway at night, the auxiliary high beams will engage to ensure the road ahead is clearly illuminated, adapting to the increasing speed of the vehicle.

In one embodiment, when the vehicle 402 decelerates or brakes, the auxiliary lights at the rear and the sides (404F, 404D, 404G, and 404H) or additional reverse lights may activate. This would be particularly helpful in low-visibility scenarios such as fog or rain. For example, when the vehicle 402 slows down to approach a stop sign at night, the auxiliary lights at the rear (e.g., 404G and 404H) may intensify, ensuring that vehicles behind are aware of the reduced speed.

In one embodiment, when the vehicle 402 shifts into reverse, the auxiliary lights at the rear and the sides (404F, 404D, 404G, and 404H) will automatically activate to provide clear illumination of the surrounding area. For example, when backing out of a parking spot at night, the system 401 will illuminate a wide area behind and to the sides of the vehicle 402, helping the driver avoid obstacles.

In one embodiment, while changing lanes at high speeds or in poorly lit areas, the system 401 can activate side-facing auxiliary lights (e.g., 404E and 404C) to help the driver see into the adjacent lane. For example, when moving from one lane to another on a dark highway, the side lights (e.g., 404E and 404C) will illuminate the target lane to ensure there are no hidden obstacles or vehicles.

In one embodiment, on curvy or winding roads, the system 401 will adjust auxiliary lights based on the sharpness of the curve detected. As the vehicle 402 approaches a sharp bend, the lights will illuminate in the direction of the curve, providing early visibility of the road ahead before the front of the vehicle 402 turns to face it. For example, during a sharp left curve, auxiliary lights on the left side will activate, helping the driver see around the corner.

In one embodiment, the system 401 may monitor the current state of the vehicle, which includes parameters such as engine status, steering angle, gear position, and the activation status of the headlights. Furthermore, the system 401 can detect the presence of any attachments, such as trailers, connected to the vehicle 402. This data allows for real-time modifications to the auxiliary lighting configuration, enhancing safety and visibility during operation.

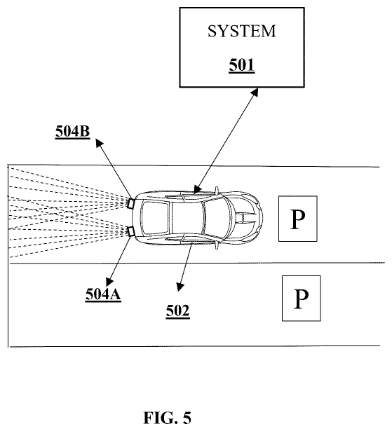

As an example, FIG. 5 illustrates a system 501 for activating auxiliary lights 504A-B during reverse movement of a vehicle 502 according to one or more embodiments. The system 501 monitors environmental lighting conditions using a sensor module or by detecting activation of headlights of the vehicle, which indicates low-light situations (e.g., parking areas or nighttime driving). In one embodiment, the parking areas are denoted as “P” in FIG. 5 If the low-light conditions are identified, the system 501 selectively activates the auxiliary lights 504A-B at the rear. The system 501 may continuously monitor auxiliary lighting configuration of the auxiliary lights 504A-B. The system 501 may activate one or more additional auxiliary lights (e.g., lights at the left and right side) among the plurality of auxiliary lights based on sensor data. In one embodiment, the system 501 detects glare in at least one of an image and a video captured during the reverse movement. In one embodiment, the image and the video are captured by a rear camera attached to the vehicle 502. The system 501 may remove the glare in at least one of the image and the video using a filter. The filter may be polarization filters, brightness correction algorithms, or software-based image processing techniques, each configured to remove the glare by analyzing intensity and angle of incoming light. In one embodiment, the system 501 detects glare by analyzing the captured image or video for overexposed regions or areas with high-intensity reflections, which are indicative of glare. Upon detecting glare, the system 501 may apply the filter configured to remove the glare, depending on the real-time environmental conditions and the current auxiliary lighting configuration of the auxiliary lights 504A-B. In one embodiment, the filter may adapt to changing lighting conditions by adjusting the contrast or reducing the brightness of specific regions in the image or video. In one embodiment, the system 501 may adjust the auxiliary lighting configuration of the one or more auxiliary lights 504A-B in response to the detected glare. This may include dimming, redirecting, or selectively deactivating specific lights to reduce the intensity of reflections or glare in the captured media. Additionally, the system 501 may recalibrate the angle or intensity of the auxiliary lights 504A-B based on the detected glare, ensuring optimal illumination while minimizing visual obstructions caused by excessive light reflections.

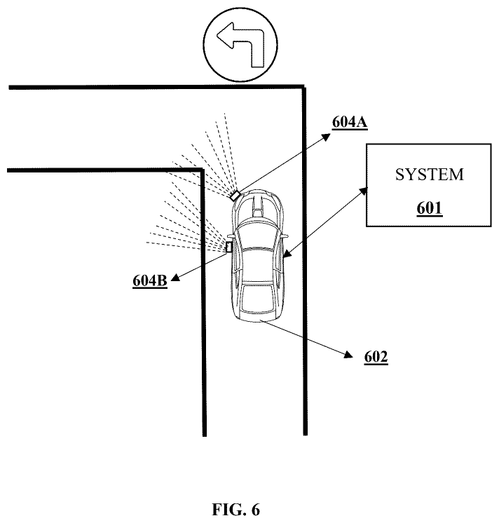

As an example, FIG. 6 illustrates a system 601 for activating auxiliary lights 604A-B during the anticipation of a left turn by a vehicle 602 according to one or more embodiments. The system 601 detects upcoming dynamic navigational changes along an anticipated travel path by correlating real-time movement of the vehicle 602 along the anticipated travel path with prestored travel path information. In one embodiment, this correlation determines that the vehicle 602 is about to make a left turn. The system 601 activates the auxiliary lights 604A-B specifically configured to illuminate the turning path of the vehicle 602 in anticipation of the left turn. The anticipated turn path of the vehicle 602 is determined by analyzing an anticipated travel route, which may be based on data from the navigation system of the vehicle or real-time driving inputs. Once the anticipated left turn path is established, the system 601 activates the auxiliary lights 604A-B on the left side of the vehicle 602 to illuminate the turning path. The auxiliary lights 604A-B on the left side of the vehicle 602 may be mounted in various locations, such as bumper, fender, side mirror, roof rack, a-pillar, rear quarter panel and left side door.

The auxiliary lights 604A-B may be adjusted in intensity or angle based on real-time environmental conditions and operating data, such as road curvature or the presence of nearby obstacles. The system 601 employs an artificial intelligence engine to ensure that the auxiliary lights 604A-B provide targeted illumination, enhancing visibility along the left turn path. Additionally, the system 601 continuously monitors and adapts the auxiliary lighting as the vehicle 602 completes the turn, maintaining effective illumination safely throughout the maneuver.

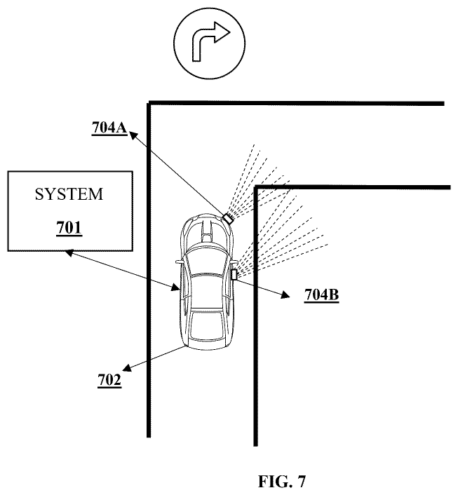

As an example, FIG. 7 illustrates an embodiment of a system 701 for activating auxiliary lights 704A-B during the anticipation of a right turn by a vehicle 702 according to one or more embodiments. The system 701 detects upcoming dynamic navigational changes along an anticipated travel path by correlating real-time movement of the vehicle 702 along the anticipated travel path with prestored travel path information. In one embodiment, this correlation determines that the vehicle 702 is about to make a right turn. The system 701 activates the auxiliary lights 704A-B specifically configured to illuminate the turning path of the vehicle 702 in anticipation of the right turn. The anticipated turn path of the vehicle 702 is determined by analyzing an anticipated travel route, which may be based on data from the navigation system of the vehicle or real-time driving inputs. Once the anticipated right turn path is established, the system 701 activates the auxiliary lights 704A-B on the right side of the vehicle 702 to illuminate the turning path. The auxiliary lights 704A-B on the right side of the vehicle 702 may be mounted in various locations, such as bumper, fender, side mirror, roof rack, a-pillar, rear quarter panel and right-side door.

The auxiliary lights 704A-B may be adjusted in intensity or angle based on real-time environmental conditions and operating data, such as road curvature or the presence of nearby obstacles. The system 701 employs an artificial intelligence engine to ensure that the auxiliary lights 704A-B provide targeted illumination, enhancing visibility along the right turn path. Additionally, the system 701 continuously monitors and adapts the auxiliary lighting as the vehicle 702 completes the turn, maintaining effective illumination safely throughout the maneuver.

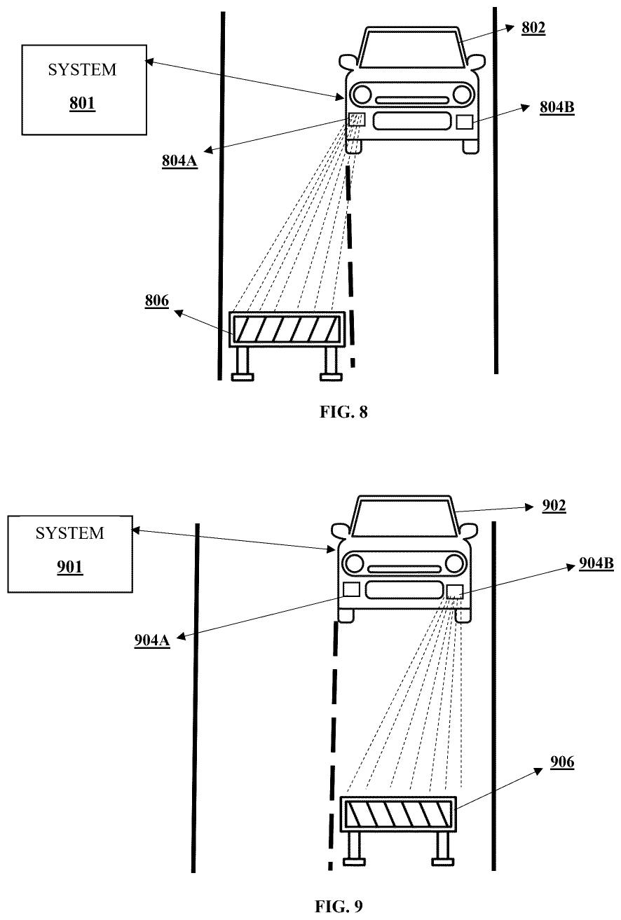

As an example, FIG. 8 illustrates a system 801 for activating auxiliary lights 804A-B when an obstacle is detected in right-side of a vehicle 802 according to one or more embodiments. The system 801 may further determine obstacles within the environment of the vehicle 802 and activate the auxiliary lights 804A-B to illuminate such obstacles, especially if close to the anticipated path of the vehicle 802. The obstacles may be barriers, rocks, pedestrians, vehicles, and other obstructions in a path of the vehicle. For example, if a side radar sensor may indicate a barrier 806 to the side (e.g., right-side) of the vehicle 802, the system 801 may activate the auxiliary lights 804A to illuminate the barrier 806 while an open side (e.g., left-side) of the vehicle 802 (e.g., 804B) may receive less, minimal, or no auxiliary lighting.

As an example, FIG. 9 illustrates an embodiment of a system 901 for activating auxiliary lights 904A-B when an obstacle is detected in left-side of a vehicle 902 according to one or more embodiments. The system 901 may further determine obstacles within the environment of the vehicle 902 and activate the auxiliary lights 904A-B to illuminate such obstacles, especially if close to the anticipated path of the vehicle 902. The obstacles may be barriers, rocks, pedestrians, vehicles, and other obstructions in a path of the vehicle. For example, if a side radar sensor may indicate a barrier 906 to the side (e.g., left-side) of the vehicle 902, the system 901 may activate the auxiliary lights 904A-B to illuminate the barrier 906 while an open side (e.g., right-side) of the vehicle 902 may receive less, minimal, or no auxiliary lighting.

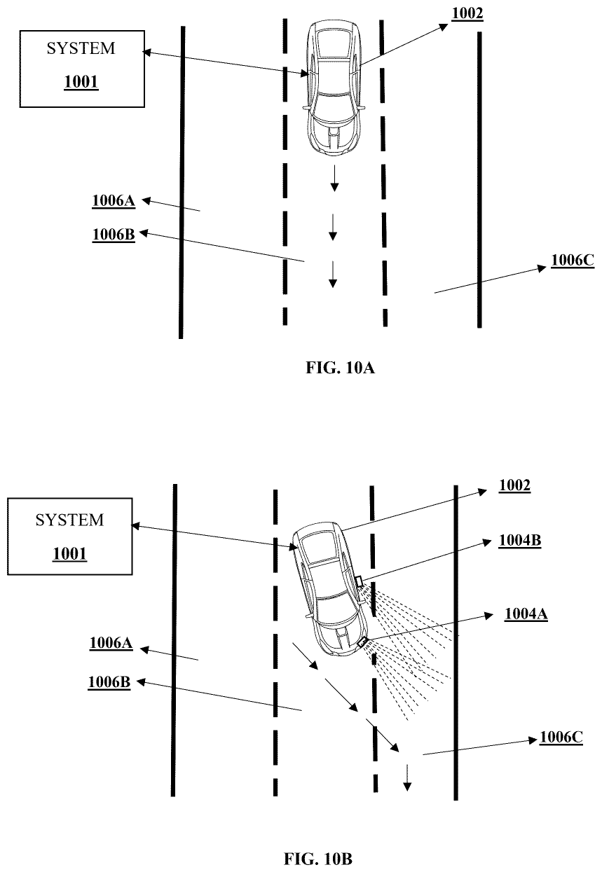

As an example, FIGS. 10A-10B illustrate a system 1001 for activating auxiliary lights 1004A-B during a lane change of a vehicle 1002 according to one or more embodiments. In FIG. 10A, the vehicle 1002 is traveling in lane 1006B, the middle lane of a multi-lane road. The adjacent lanes are labelled 1006A on the left and 1006C on the right. At this point, the vehicle 1002 may maintain its position in the lane 1006B with no changes in trajectory. The system 1001 continuously monitors the environment of the vehicle, including other traffic, road conditions, and potential hazards, preparing for any necessary adjustments in navigation. The auxiliary lights remain inactive as the vehicle 1002 proceeds steadily in the center lane.

In FIG. 10B, the vehicle 1002 begins transitioning from the lane 1006B to the lane 1006C, potentially due to an obstacle or slower-moving vehicle in the lane 1006B, upcoming road conditions such as a construction zone, or the need to prepare for an exit. The system 1001 anticipates this dynamic navigational change and automatically activates the auxiliary lights 1004A-B on the left side and the front-left corner of the vehicle 1002. This lighting enhances visibility, illuminating the adjacent lane and the path ahead, ensuring a safer and smoother lane change into lane 1006C, particularly in low-visibility or complex driving conditions.

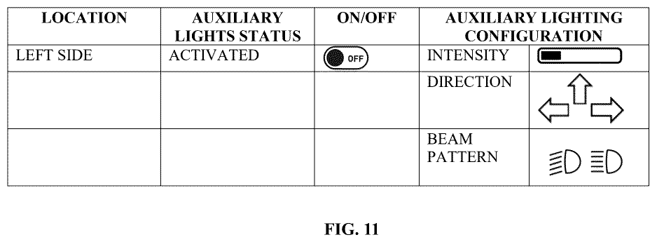

As an example, FIG. 11 illustrates an interactive menu of a vehicle for controlling auxiliary lighting configuration according to one or more embodiments. The interactive menu displays which auxiliary light is activated, indicating the specific location, such as the left side when the left auxiliary light is on. The interactive menu further displays auxiliary light status (e.g., activated or deactivated). The interactive menu includes an activate/deactivate switch for an operator to conveniently turn the auxiliary lights on or off, and an intensity control slider enables easy adjustment of the auxiliary lights' brightness, with settings ranging from 0% to 100%. Furthermore, the interactive menu provides options for customizing the auxiliary lighting configuration, allowing the operator to modify both the direction (e.g., left, right, or straight ahead) and the beam pattern (e.g., low beam or high beam) of the activated lights, ensuring optimal visibility for various driving conditions. The system may monitor auxiliary lighting adjustments specific to an occupant of the vehicle and store the auxiliary lighting adjustments as preferences in a database. The system may recognize an identity of a vehicle occupant and provide the auxiliary lighting adjustments based on the preferences for that specific occupant in future.

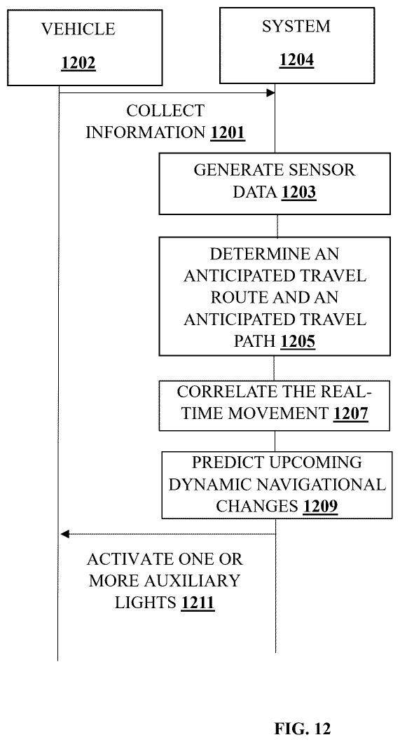

As an example, FIG. 12 illustrates a communication flow between a system 1204 and a vehicle 1202 according to one or more embodiments. At step 1201, the system 1204 collects current route information, real-time movement of the vehicle 1202, real-time environmental conditions, real-time vehicle operating conditions, real-time traffic conditions, real-time travel path information and obstacles information from a sensor module associated with the vehicle 1202 and generate sensor data based on the detection at step 1203. At step 1205, the system 1204 determines, using an artificial intelligence engine, an anticipated travel route and an anticipated travel path of the vehicle 1202 based on the sensor data. At step 1207, the system 1204 correlates the real-time movement of the vehicle 1202 along the anticipated travel path with prestored travel path information. At step 1209, the system 1204 predicts one or more upcoming dynamic navigational changes along the anticipated travel path based on the correlation. At step 1211, the system 1204 selectively activates, using the artificial intelligence engine, one or more auxiliary lights among the plurality of auxiliary lights to illuminate the anticipated travel path of the vehicle 1202 based on the one or more upcoming dynamic navigational changes.

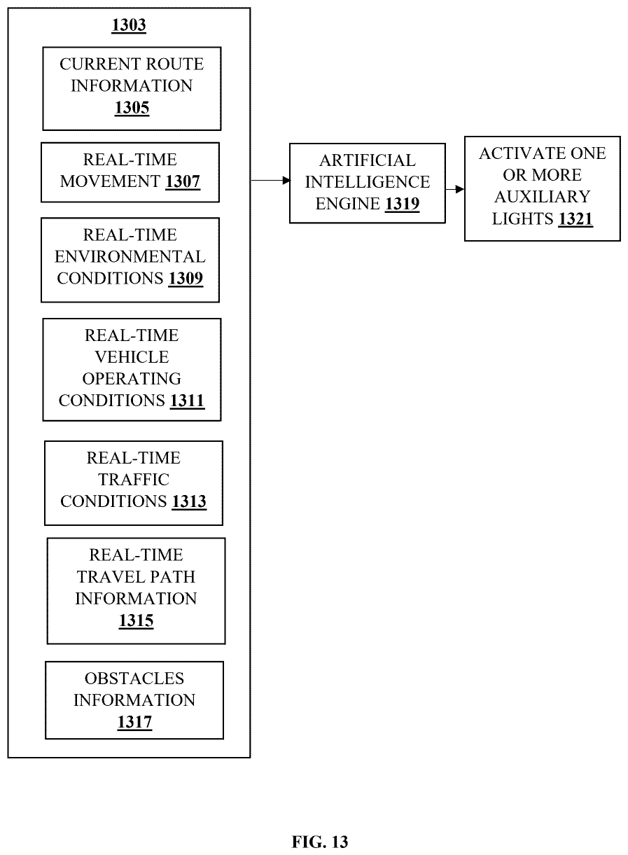

As an example, FIG. 13 shows an example block diagram for an artificial intelligence engine 1319 used in activating one or more auxiliary lights among a plurality of auxiliary lights of a vehicle according to one or more embodiments. The artificial intelligence engine 1319 obtains sensor data from a sensor module 1303 configured in the vehicle. The sensor data comprises at least one of current route information 1305, real-time movement of the vehicle 1307, real-time environmental conditions 1309, real-time vehicle operating conditions 1311, real-time traffic conditions 1313, real-time travel path information 1315 and obstacles information 1317.

In one embodiment, the current route information 1305 comprises source, destination, distance, estimated travel time, waypoints of interest, geographic location of the vehicle, navigation route, road type, and turn-by-turn directions. In one embodiment, the real-time movement of the vehicle 1307 comprises a current location of the vehicle 1307, speed of the vehicle 1307, a direction of movement of the vehicle 1307, and a movement pattern of the vehicle 1307. The real-time environmental conditions 1309 may comprise ambient light levels, reflective surfaces, weather conditions, visibility range, light sources within an environment of the vehicle, and rate of precipitation. The real-time vehicle operating conditions 1311 may comprise acceleration metrics, engine status, steering angle, gear selection, headlights status, and a vehicle attachment. In one embodiment, the real-time traffic conditions 1313 comprise traffic density, vehicle proximity, traffic light status, lane occupancy, road closures, and alternate route suggestions. In one embodiment, the real-time travel path information 1315 comprises anticipated turns, road curvature, elevation changes, path signs, and road surface conditions. In one embodiment, the obstacles information 1317 comprises stationary objects, moving vehicles, pedestrians, road infrastructure, and road hazards detected within an area around the vehicle. The artificial intelligence engine 1319 determines an anticipated travel route and an anticipated travel path of the vehicle based on the sensor data. The processor correlates the real-time movement of the vehicle along the anticipated travel path with prestored travel path information and predicts one or more upcoming dynamic navigational changes along the anticipated travel path based on the correlation. The artificial intelligence engine 1319 selectively activates one or more auxiliary lights 1321 among the plurality of auxiliary lights to illuminate the anticipated travel path of the vehicle based on the one or more upcoming dynamic navigational changes.

In an embodiment, the machine learning model is configured to learn using labelled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment of the system, the machine learning model is configured to learn from the real-time data using an unsupervised learning method, wherein the unsupervised learning method comprises logic using at least one of a k-means clustering, a hierarchical clustering, a hidden Markov model, and an apriori algorithm.

In an embodiment of the system, the machine learning model has a feedback loop, wherein the output from a previous step is fed back to the model in real-time to improve the performance and accuracy of the output of a next step.

In an embodiment of the system, the machine learning model comprises a recurrent neural network model.

In an embodiment of the system, the machine learning model has a feedback loop, wherein the learning is further reinforced with a reward for each true positive of the output of the system.

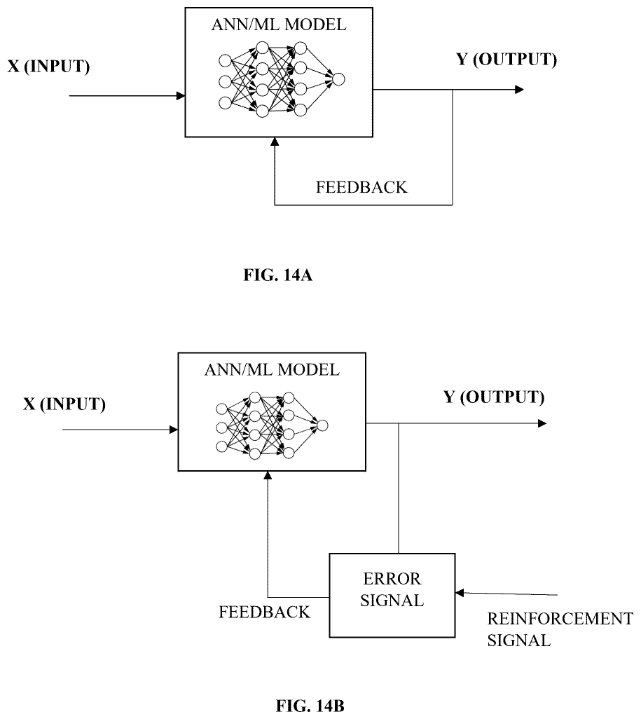

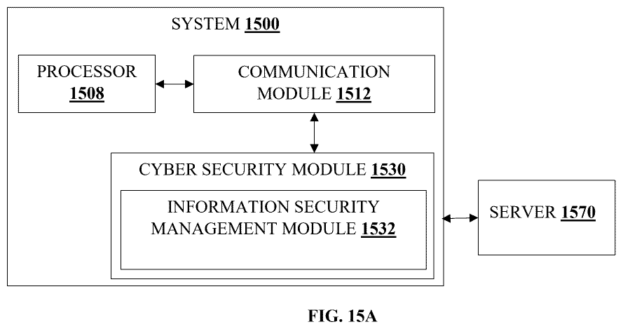

As an example, FIG. 14A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may selectively activate one or more auxiliary lights among a plurality of auxiliary lights to illuminate the anticipated travel path of the vehicle based on the one or more upcoming dynamic navigational changes.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN). Neural Networks can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback (error signal). The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the Artificial Intelligence/Machine Learning (AI/ML) model is trained well, with large sets of labelled data and concepts, after a while, the models' performance may decline while adding new, unlabelled input due to many reasons which include, but not limited to, concept drift, recall precision degradation due to drifting away from true positives, and data drift over time. A feedback loop in the model keeps the AI results accurate and ensures that the model maintains its performance and improvement, even when new unlabelled data is assimilated. A feedback loop refers to the process by which an AI model's predicted output is reused to train new versions of the model.

Initially, when the AI/ML model is trained, a few labelled samples comprising both positive and negative examples of the concepts (for e.g., selectively activate one or more auxiliary lights, etc.) are used that are meant for the model to learn. Afterward, the model is tested using unlabelled data. By using, for example, deep learning and neural networks, the model can then make predictions on whether the desired concept/s (for e.g., selectively activate one or more auxiliary lights, etc.) are in unlabelled images. Each image is given a probability score where higher scores represent a higher level of confidence in the models' predictions. Where a model gives an image a high probability score, it is auto labelled with the predicted concept. However, in the cases where the model returns a low probability score, this input may be sent to a controller (may be a human moderator) which verifies and, as necessary, corrects the result. The human moderator may be used only in exception cases. The feedback loop feeds labelled data, auto-labelled or controller-verified, back to the model dynamically and is used as training data so that the system can improve its predictions in real-time and dynamically.

As an example, FIG. 14B shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labelled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

In an embodiment, icons on a graphical user interface (GUI) or display of the infotainment system of a computer system are re-arranged based on a priority score of the content of the message. The processor tracks the messages that need to be displayed at a given time and generates a priority score, wherein the priority score is determined based on the action that needs to be taken by the user, the time available before the user input is needed, content of the message to be displayed, criticality of the user's input/action that needs to be taken, the sequence of the message or messages that need to be displayed and executed, and the safety of the overall scenario. For example, in case of a health emergency, the messages in queue for displaying could be an emergency signal, type of emergency, intimation that an alert is provided to the nearby vehicles, instructing a path for the driver to pull over, calling the emergency services, etc. In all these messages that need a driver's attention, a priority score is provided based on the actions that need to be taken by the user, the time available for the user to receive the displayed message and react with an action, the content of the message, criticality of the user's input/action, sequence of the messages that need to be executed, and safety of the overall scenario. Considering the above example, the message that intimates the user/driver that an alert has been provided to nearby vehicles may be of lower priority as compared to instructing the path for the driver to pull over. Therefore, the pull over directions for the path message takes priority and takes such a place on the display (example, center of the display) which can grab the users' attention immediately. The priorities of the messages are evaluated dynamically as the situation is evolving and thus the display icons, positions, and sizes of the text or icon on the display are changed in real-time and dynamically. In an embodiment, more than one message is displayed and highlighted as per the situation and the user's actions. Further, while pulling over, if an unsafe scenario is found, for example, a car is changing lanes which may obstruct the user's vehicle, the message dynamically changes and warns the driver about the developing scenario. In another scenario of a vehicle with charge less than threshold charge level, the processor dynamically reassigns the priority score and depicts nearby charging station and navigates the route to the charging station onto a display in the dashboard.

In an embodiment, the system further comprises a cyber security module wherein the cyber security module comprises an information security management module providing isolation between the communication module and servers.

In an embodiment, the information security management module is operable to, receive data from the communication module, exchange a security key at a start of the communication between the communication module and the server, receive the security key from the server, authenticate an identity of the server by verifying the security key, analyze the security key for a potential cyber security threat, negotiate an encryption key between the communication module and the server, encrypt the data; and transmit the encrypted data to the server when no cyber security threat is detected.

In an embodiment, the information security management module is operable to exchange a security key at a start of the communication between the communication module and the server, receive the security key from the server, authenticate an identity of the server by verifying the security key, analyze the security key for a potential cyber security threat, negotiate an encryption key between the system and the server, receive encrypted data from the server, decrypt the encrypted data, perform an integrity check of the decrypted data and transmit the decrypted data to the communication module when no cyber security threat is detected.

In an embodiment, the system may comprise a cyber security module.

In one aspect, a secure communication management (SCM) computer device for providing secure data connections is provided. The SCM computer device includes a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system.

According to an embodiment, secure authentication for data transmissions comprises, provisioning a hardware-based security engine (HSE) located in the information security management module, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

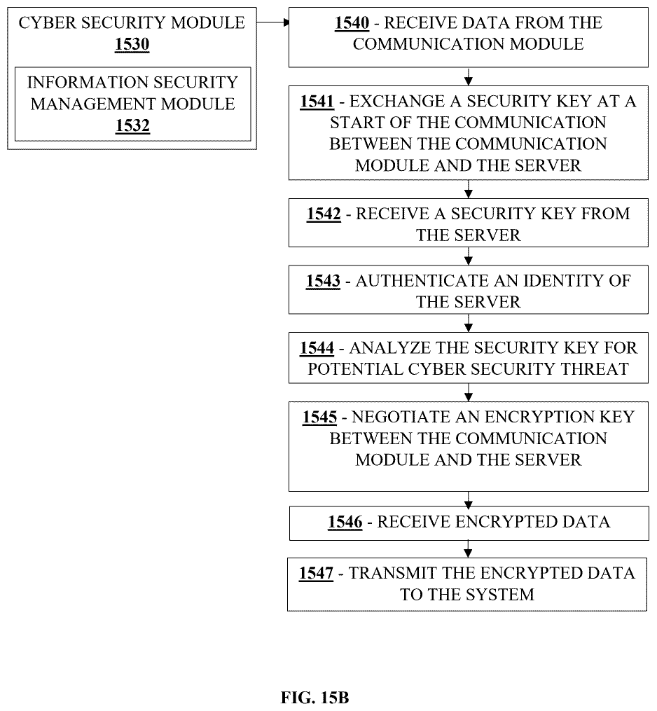

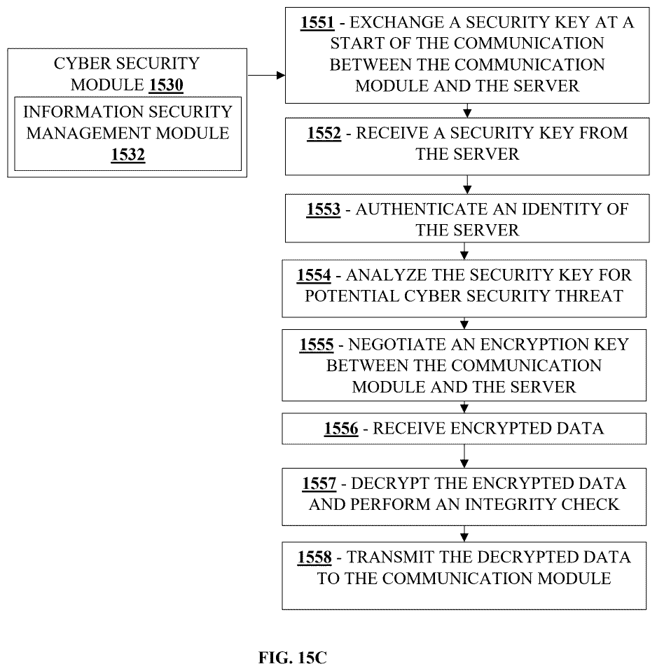

In an embodiment, FIG. 15A shows the block diagram of the cyber security module. The communication of data between the system 1500 and the server 1570, through the processor 1508, through the communication module 1512, is first verified by the information security management module 1532 before being transmitted from the system to the server or from the server to the system. The information security management module is operable to analyze the data for potential cyber security threats, to encrypt the data when no cyber security threat is detected, and to transmit the data encrypted to the system or the server.

In an embodiment, the cyber security module further comprises an information security management module providing isolation between the system and the server. FIG. 15B shows the flowchart of securing the data through the cyber security module 1530. At step 1540, the information security management module 1532 is operable to receive data from the communication module. At step 1541, the information security management module exchanges a security key at a start of the communication between the communication module and the server. At step 1542, the information security management module receives a security key from the server. At step 1543, the information security management module authenticates an identity of the server by verifying the security key. At step 1544, the information security management module analyzes the security key for potential cyber security threats. At step 1545, the information security management module negotiates an encryption key between the communication module and the server. At step 1546, the information security management module receives the encrypted data. At step 1547, the information security management module transmits the encrypted data to the server when no cyber security threat is detected.

In an embodiment, FIG. 15C shows the flowchart of securing the data through the cyber security module 1530. At step 1551, the information security management module 1532 is operable to: exchange a security key at a start of the communication between the communication module and the server. At step 1552, the information security management module receives a security key from the server. At step 1553, the information security management module authenticates an identity of the server by verifying the security key. At step 1554, the information security management module analyzes the security key for potential cyber security threats. At step 1555, the information security management module negotiates an encryption key between the communication module and the server. At step 1556, the information security management module receives encrypted data. At step 1557, the information security management module decrypts the encrypted data, and performs an integrity check of the decrypted data. At step 1558, the information security management module transmits the decrypted data to the communication module when no cyber security threat is detected.

In an embodiment, the integrity check is a hash-signature verification using a Secure Hash Algorithm 256 (SHA256) or a similar method.

In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 15A, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting a Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

Other specific forms may embody the present invention without departing from its spirit or characteristics. The embodiments described are in all respects illustrative and not restrictive. Therefore, the appended claims rather than the description herein indicate the scope of the invention. All variations which come within the meaning and range of equivalency of the claims are within their scope.

1-67. (canceled)

68. A system comprising:
a plurality of auxiliary lights positioned at one or more locations of a vehicle;
a sensor module configured to detect at least one of current route information, a real-time movement of the vehicle, real-time environmental conditions, real-time vehicle operating conditions, real-time traffic conditions, real-time travel path information and obstacles information and generate sensor data based on the detection; and
a processor communicatively coupled to the plurality of auxiliary lights, the sensor module, and the processor storing instructions in non-transitory memory that, when executed, causes the processor to:
receive the sensor data from the sensor module;
determine, using an artificial intelligence engine, an anticipated travel route and an anticipated travel path of the vehicle based on the sensor data;
correlate the real-time movement of the vehicle along the anticipated travel path with prestored travel path information;
predict one or more upcoming dynamic navigational changes along the anticipated travel path based on the correlation; and
selectively activate, using the artificial intelligence engine, one or more auxiliary lights among the plurality of auxiliary lights to illuminate the anticipated travel path of the vehicle based on the one or more upcoming dynamic navigational changes.

69. The system of claim 68, wherein the one or more upcoming dynamic navigational changes comprise anticipated turns, lighting changes, acceleration, deceleration, a movement of the vehicle within a parking space, reverse movement, speed changes, direction changes, and lane changes.

70. The system of claim 68, wherein the processor is operable to activate one or more additional auxiliary lights among the plurality of auxiliary lights.

71. The system of claim 70, wherein the processor is operable to adjust auxiliary lighting configuration of the one or more auxiliary lights.

72. The system of claim 71, wherein the auxiliary lighting configuration comprises intensity, direction, and beam pattern of the one or more auxiliary lights that are activated among the plurality of auxiliary lights.

73. The system of claim 71, wherein the processor is operable to determine that the auxiliary lighting configuration is within a threshold.

74. The system of claim 73, wherein the processor is operable to activate the one or more additional auxiliary lights among the plurality of auxiliary lights if the auxiliary lighting configuration is less than the threshold.

75. The system of claim 73, wherein the processor is operable to adjust the auxiliary lighting configuration of the one or more auxiliary lights if the auxiliary lighting configuration is less than the threshold.

76. The system of claim 71, wherein the processor is operable to detect glare in at least one of an image and a video captured during reverse movement.

77. The system of claim 76, wherein the processor is operable to remove the glare in at least one of the image and the video using a filter.

78. The system of claim 77, wherein the filter is configured to remove the glare based on the real-time environmental conditions of the vehicle and current auxiliary lighting configuration.

79. The system of claim 76, wherein the processor is operable to adjust the auxiliary lighting configuration of the one or more auxiliary lights in response to the detected glare.

80. A method comprising:
receiving sensor data from a sensor module;
determining, using an artificial intelligence engine, an anticipated travel route and an anticipated travel path of a vehicle based on the sensor data;
correlating a real-time movement of the vehicle along the anticipated travel path with prestored travel path information;
predicting one or more upcoming dynamic navigational changes along the anticipated travel path based on the correlation; and
selectively activating, using the artificial intelligence engine, one or more auxiliary lights among a plurality of auxiliary lights to illuminate the anticipated travel path of the vehicle based on the one or more upcoming dynamic navigational changes.

81. The method of claim 80, further comprising: displaying an interactive menu onto a display of the vehicle depicting auxiliary lighting controls of the one or more auxiliary lights upon activation.

82. The method of claim 81, wherein the auxiliary lighting controls allow an operator to at least one of adjust auxiliary lighting configuration, activate and deactivate the one or more auxiliary lights.

83. A non-transitory computer readable storage medium comprising a sequence of instructions, which when executed by a processor causes:
receiving sensor data from a sensor module;
determining, using an artificial intelligence engine, an anticipated travel route and an anticipated travel path of a vehicle based on the sensor data;
correlating a real-time movement of the vehicle along the anticipated travel path with prestored travel path information;
predicting one or more upcoming dynamic navigational changes along the anticipated travel path based on the correlation; and
selectively activating, using the artificial intelligence engine, one or more auxiliary lights among a plurality of auxiliary lights to illuminate the anticipated travel path of the vehicle based on the one or more upcoming dynamic navigational changes.

84. The non-transitory computer readable storage medium of claim 83, further comprising:
monitoring auxiliary lighting adjustments specific to an occupant of the vehicle and storing the auxiliary lighting adjustments as preferences in a database.

85. The non-transitory computer readable storage medium of claim 84, further comprising:
recognizing an identity of a vehicle occupant and providing the auxiliary lighting adjustments based on the preferences for that specific occupant in future.

86. The non-transitory computer readable storage medium of claim 83, further comprising:
training the artificial intelligence engine based on the sensor data.

87. The non-transitory computer readable storage medium of claim 86, further comprising:
communicating, using the artificial intelligence engine, instructions to the processor to activate the one or more auxiliary lights among the plurality of auxiliary lights based on learning.
